(19) United States
(12) Patent Application Publication
(10) Pub. No.: US 2012/0057864 A1
(43) Pub. Date: Mar. 8, 2012

(54) OPTICAL TRANSMISSION APPARATUS INCLUDING COOLER

(75) Inventor: Kwon Seob Lim, Gwangju (KR)

(73) Assignee: ELECTRONICS AND TELECOMMUNICATIONS RESEARCH INSTITUTE, Daejeon (KR)

(21) Appl. No.: 13/226,392

(22) Filed: Sep. 6, 2011

(30) Foreign Application Priority Data
Sep. 6, 2010 (KR) 10-2010-0087002

(51) Int. Cl. H04B 10/04; H04B 10/08

(52) U.S. Cl. 398/9; 398/200

(57) ABSTRACT

An optical transmission apparatus including a cooler includes: a platform having a transmission line patterned to have an angle of 90°; a light source mounted on the platform such that it is connected to the transmission line of the platform and generating light; a cooler positioned under the platform and uniformly maintaining the temperature of the light source; and a transistor outline (TO) stem package allowing the platform to be mounted thereon and having a lead pin connected to the transmission line of the platform through a bonding wire. Temperature control characteristics are provided, high frequency characteristics are improved, and a lens, or the like, can be mounted in a passive alignment manner.

### CROSS-REFERENCE TO RELATED APPLICATIONS

This application claims the priority of Korean Patent Application No. 10-2010-0087002 filed on Sep. 6, 2010, in the Korean Intellectual Property Office, the disclosure of which is incorporated herein by reference.

### BACKGROUND OF THE INVENTION

1. Field of the Invention

The present invention relates to an optical transmission apparatus and, more particularly, to an optical transmission apparatus including a cooler for controlling the temperature thereof.

2. Description of the Related Art

Wavelength division multiplexing passive optical network technology (WDM-PON) is a communications technology for multiplexing optical signals of different wavelengths using single optical fiber, and transmitting the same.

WDM-PON does not cause interference between optical signals of different wavelengths, and allocates a unique wavelength to each subscriber, thereby guaranteeing a symmetrical bidirectional broadband service, and also, allows only a particular subscriber to receive an optical signal of a particular wavelength, thereby providing excellent privacy and security to users. Such a WDM technique has been commonly used in an existing backbone network, and recently, there has been a move to extend its coverage to even a subscriber network.

In the case of optical communications using WDM, secure temperature stability of wavelengths, in comparison with time-division multiplexing and frequency division multiplexing, is required. Thus, in order to secure temperature stability in an optical module, namely, to prevent malfunctions due to a wavelength transition according to temperature, a thermo-electric cooler is required to control an operational temperature of a light source to a certain level. Research about an optical transmission apparatus using a square ceramic package such as a butterfly package and a TEC has been widely conducted.

However, optical transceivers tend to be reduced in size for coping with the tendency for so-called small form factor pluggable (SFP) platforms. And demands for a transistor outline (TO) type optical transmission apparatus, previously widely used in conventional optical apparatuses, has gradually risen.

In the case of the TO type optical transmission apparatus including TEC, a method of converting a 90-degree optical path by using a 45-degree mirror to make an optical axis formed to be perpendicular to a TO-stem base, or processing a simple L-shaped structure and mounting a light source on a protrusive portion and connecting it to a lead pin through wire bonding, with some difficulty, is generally used.

However, when the 45-degree mirror is used, it is difficult to process a 45-degree reflective face, and a process of aligning the light source and the mirror is additionally required.

In addition, when the simple L-shaped structure is used, a sub-mount is required so as to mount a light source thereon, and there may be difficulty in performing wire bonding on a rounded face of a rounded cylindrical lead pin. Also, since the bonding wire is elongated, high frequency characteristics deteriorate, so the method is only applicable to a low-speed optical transmission apparatus.

### SUMMARY OF THE INVENTION

An aspect of the present invention provides an optical transmission apparatus including a cooler capable of providing temperature control properties thereto.

Another aspect of the present invention provides an optical transmission apparatus capable of improving high frequency characteristics.

Another aspect of the present invention provides an optical transmission apparatus capable of allowing a lens, or the like, to be mounted in a passive alignment manner.

According to an aspect of the present invention, there is provided an optical transmission apparatus including: a platform having a transmission line patterned to have an angle of 90°; a light source mounted on the platform such that it is connected to the transmission line of the platform and generating light; a cooler positioned under the platform and uniformly maintaining the temperature of the light source; and a transistor outline (TO) stem package allowing the platform to be mounted thereon and having a lead pin connected to the transmission line of the platform through a bonding wire.

The platform may include a first platform on which the transmission line is patterned; and a second platform on which the transmission line is patterned, and which is coupled to the first platform at a right angle, wherein the transmission line of the first platform and that of the second platform are connected at an angle of 90°, and the apparatus may further include: a monitoring light receiving element mounted on the second platform and monitoring the light source.

The first platform and the second platform may each have one face formed as a sloped face, the transmission line may be patterned on an upper face and on the sloped face of each of the first and second platforms, the first and second platforms may be bonded at a right angle using the sloped faces. Further, a solder may be formed on the sloped faces of the first and second platforms, and the first and second platforms may thereafter be bonded at a right angle through a flipchip bonding process.

The platform may further include a sloped face formed at an inner corner area where the first and second platforms are in contact, the light source may be mounted on the second platform, and the apparatus may further include: a monitoring light receiving element mounted on the second platform or the first platform and monitoring the light source.

The platform may further include a protruded face formed at the edge of the first platform such that it faces the sloped face, and the apparatus may further include: a monitoring light receiving element mounted on the second platform or the protruded face of the first platform and monitoring the light source.

The platform may further include a V-groove, and the apparatus may further include a lens, an isolator, or a lens including an isolator, mounted in the V-groove.

The TO stem package may include a base allowing the platform to be mounted thereon; a lead pin connected to the transmission line of the platform through a bonding wire; and an insulator formed in an area in which the base and the lead pin are in contact.

The TO stem package may further include a cavity formed in the base.

The cooler may be mounted in the cavity.

The base may have a circular or quadrangular shape.

The apparatus may further include: a thin film resistor formed on the transmission line or a chip resistor bonded to the transmission line; and a thermistor mounted on the platform and connected to the transmission line.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a side sectional view of an optical transmission apparatus according to an embodiment of the present invention;

FIG. 2 is a plan view of the optical transmission apparatus according to an embodiment of the present invention;

FIG. 3 is a schematic perspective view of the optical transmission apparatus according to an embodiment of the present invention;

FIGS. 4A through 4C are views showing platforms according to an embodiment of the present invention;

FIG. 5 is a schematic perspective view of a platform according to an embodiment of the present invention;

FIG. 6 is a schematic perspective view of a platform according to another embodiment of the present invention;

FIGS. 7A to 7C are views showing implementation examples of a platform according to an embodiment of the present invention;

FIG. 8 is a view showing an implementation example of a transistor outline (TO) stem package according to an embodiment of the present invention;

FIGS. 9A and 9B are views showing a configuration in which a cap is fastened to an optical transmission apparatus according to an embodiment of the present invention;

FIG. 10 is a graph of frequency characteristics of a transmission line of a platform itself according to an embodiment of the present invention;

FIG. 11 is a graph of frequency transmission characteristics of the optical transmission apparatus after mounting a TO stem package on a platform according to an embodiment of the present invention; and

FIG. 12 is an eye diagram of output signals obtained when a signal having an optical transmission speed of 10 Gb/s is applied in a state in which the TO stem package is mounted on the platform according to an embodiment of the present invention.

### DETAILED DESCRIPTION OF THE PREFERRED EMBODIMENT

The present invention may be embodied in many different forms and have various embodiments which will be illustrated in drawings and described in detail.

However, it should be understood that the following exemplifying description of the invention is not meant to restrict the invention to specific forms of the present invention but rather the present invention is meant to cover all modifications, similarities and alternatives which are included in the spirit and scope of the present invention.

It will be understood that, although the terms first, second, etc. may be used herein to describe various elements, these elements should not be construed as being limited by these terms. These terms are only used to distinguish one element from another. For example, a first element could be termed a second element, and, similarly, a second element could be termed a first element, without departing from the scope of the present invention. The term “and/or” encompasses both combinations of the plurality of related items disclosed and any item from among the plurality of related items disclosed.

It will be understood that when an element is referred to as being “connected with” another element, it can be directly connected with the other element or intervening elements may also be present. In contrast, when an element is referred to as being “directly connected with” another element, there are no intervening elements present.

The terms used in the present application are merely used to describe particular embodiments, and are not intended to limit the present invention. An expression used in the singular encompasses the expression of the plural, unless it has a clearly different meaning in the context. In the present application, it is to be understood that terms such as “including” or “having,” etc., are intended to indicate the existence of features, numbers, operations, actions, components, parts, or combinations thereof disclosed in the specification, and are not intended to preclude the possibility that one or more other features, numbers, operations, actions, components, parts, or combinations thereof may exist or be added.

Unless otherwise defined, all terms used herein, including technical or scientific terms, have the same meanings as those generally understood by those having ordinary knowledge in the field of art to which the present invention belongs. Such terms as those defined in a generally used dictionary are to be interpreted as having meanings equal to the contextual meanings in the relevant field of art, and are not to be interpreted to have ideal or excessively formal meanings unless clearly defined in the present application.

Embodiments of the present invention will be described below in detail with reference to the accompanying drawings, where those components are rendered the same reference number that are the same or are in correspondence, regardless of the reference number, and redundant explanations are omitted. In describing the present invention, if a detailed explanation for a related known function or construction is considered to unnecessarily divert from the gist of the present invention, such explanation has been omitted, but would be understood by those skilled in the art.

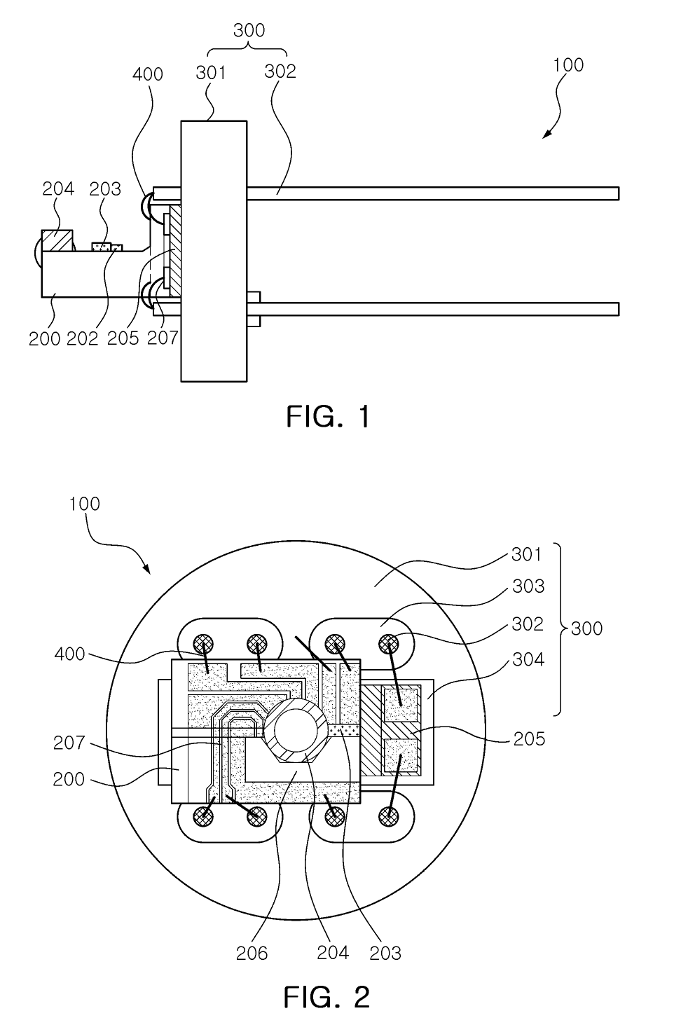

FIGS. 1 to 3 are views for explaining the structure of an optical transmission apparatus according to an embodiment of the present invention.

With reference to FIGS. 1 to 3, the optical transmission apparatus 100 may includes a platform 200 having a transmission line 207 patterned to have an angle of 90°, a light source 201 mounted on the platform 200 such that it is connected to the transmission line 207 of the platform 200, a monitoring light receiving element 202, a thermistor 203, a cooler 205 positioned under the platform 200 to maintain a uniform temperature of the light source 201, and a transistor outline (TO) stem package 300 having the platform mounted thereon and including a lead pin 302 connected to the transmission line 207 of the platform 200 through a bonding wire 400.

The light source 201 generates light to be transmitted to the exterior (e.g., an optical fiber), and the monitoring light receiving element 202 serves to monitor the quantity of light generated by the light source 201 while the thermistor 203 measures the temperature of the light source 201.

Further, in the optical transmission apparatus 100 a V-groove 206 may be formed in the platform 200, and a lens 204 for focusing light from the light source 201 to the exterior may be additionally mounted in a passive alignment manner.

In addition, a thin film resistor 208 is formed when the transmission line is formed, in order to broadband-impedance-match the light source 201 and an external driving circuit. However, according to specific circumstances, a chip resistor, instead of the thin film resistor 208, may be mounted on the transmission line 207 to broadband-impedance-match the light source 201 and an external driving circuit.

The structure of the light transmission apparatus 100 configured as described above will now be described in detail.

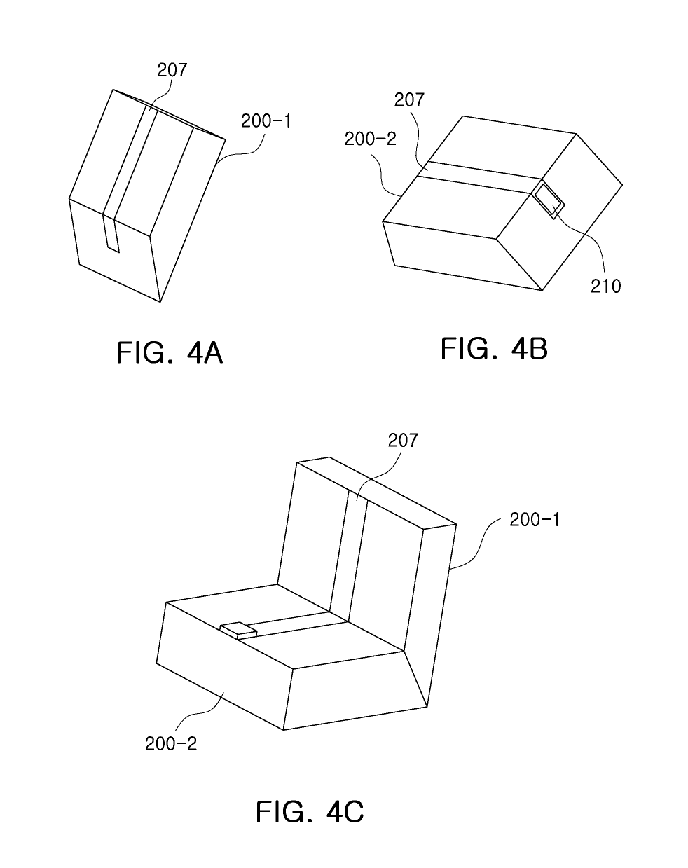

FIGS. 4A through 4C show a platform according to an embodiment of the present invention. A first platform 200-1 and a second platform 200-2 are separately manufactured, as shown in FIGS. 4A and 4B, and then bonded, as shown in FIG. 4C, to form a transmission line having an angle of 90°. In detail, the first platform 200-1 and the second platform 200-2 each have one face formed as a sloped face, a transmission line is patterned on an upper face and the sloped face of each of the first platform 200-1 and the second platform 200-2, and the first platform 200-1 and the second platform 200-2 are bonded at a right angle using the sloped faces of the first platform 200-1 and the second platform 200-2, thus electrically connecting the transmission lines. In particular, a solder 210 may be formed on the sloped face of each of the first platform 200-1 and the second platform 200-2, and the first platform 200-1 and the second platform 200-2 may thereafter be bonded through a flipchip bonding process.

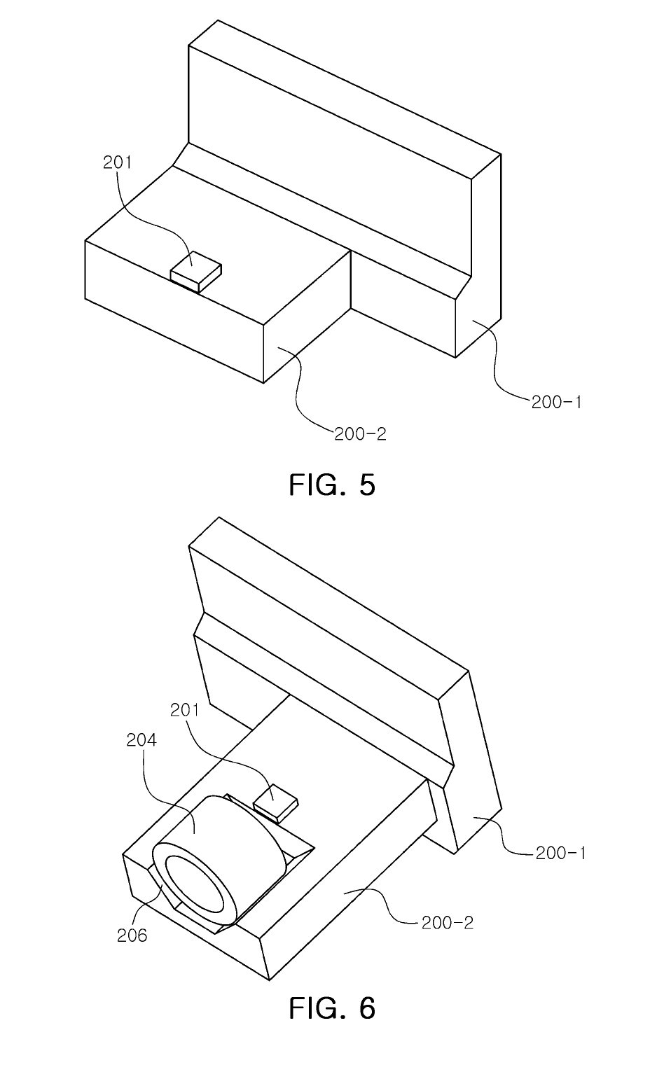

FIG. 5 is a view for explaining the structure of the platform according to an embodiment of the present invention.

With reference to FIGS. 1 to 3, and 5, it is noted that the platform 200 includes the transmission line 207 patterned to have an angle of 90°.

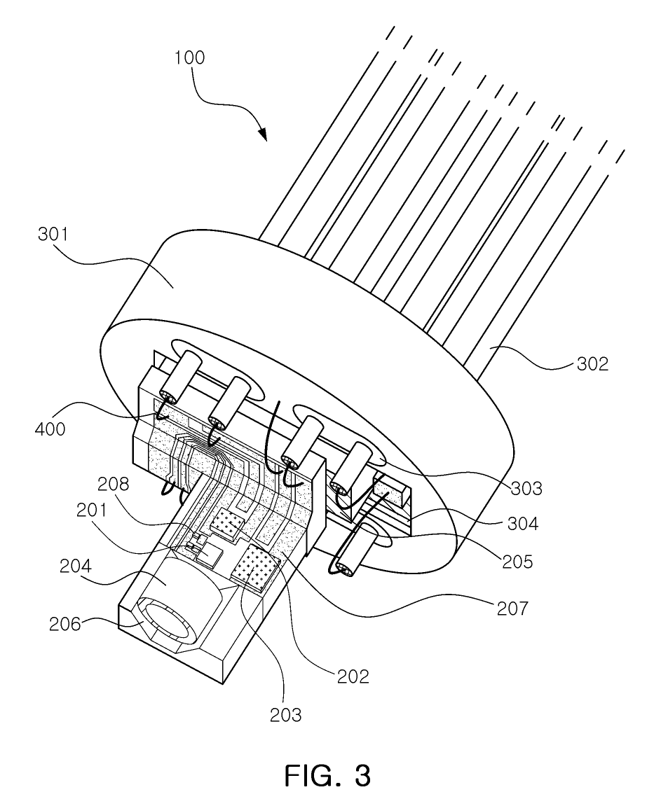

Also, as shown in FIG. 3, it is noted that the transmission line 207 is connected to the lead pin 302 of the TO stem package 300 through the bonding wire 400, and the elements 201, 202, and 203 are indirectly connected to the lead pin 302 through the transmission line 207 and the bonding wire 400.

In this manner, in an embodiment of the present invention, the transmission line 207 is formed on the platform 200, and the length of the bonding wire 400 used for connection between the internal elements 201, 202, and 203 and the lead pin 302 is minimized.

For reference, in the related prior art, the internal elements 201, 202, and 203 and the lead pin 302 in the optical transmission apparatus 100 are directly connected through the bonding wire 400. In this case, however, the bonding wire 400 has strong signal noise, loss and crosstalk characteristics with respect to an RF signal, so the increase in the length of the bonding wire 400 leads to a degradation of the high frequency characteristics of the optical transmission apparatus 100.

Thus, in an embodiment of the present invention, the transmission line 207 having excellent high frequency characteristics is formed on the platform 200, and the majority of the bonding wire 400 used for a connection between the internal elements 201, 202, and 203 and the lead pin 302 is replaced by the transmission line 207, thus improving the high frequency characteristics of the optical transmission apparatus 100.

FIG. 6 is a perspective view of a platform according to another embodiment of the present invention.

With reference to FIGS. 1 to 3, and 6, unlike the platform of FIG. 5, the platform 200 further includes a V-groove 206, and the lens 204 may be mounted in the V-groove 206 in a passive alignment manner. Here, the platform 200 may be implemented by a silicon wafer, or the like, to facilitate the formation of the V-groove 206.

Namely, in an embodiment of the present invention, the V-groove 206 is formed, and the light source 201 and the lens 204 are passively aligned by using the V-groove 206, whereby a process of optically aligning a cap having a lens or a metal holder having a lens and the light source 201 can be omitted and a work-off problem which may be generated after elements are mounted can be solved.

In particular, in order to avoid a post-weld shifting problem generated in mounting a lens by using laser welding, the platform 200 may be implemented by a silicon wafer, or the like, to facilitate the formation of the V-groove 206.

In the optical transmission module 100, an isolator, or a lens having the isolator, may be mounted instead of the lens 204, and also in this case, the effect of omitting a follow-up process, such as an alignment, or the like, for mounting the isolator can be provided.

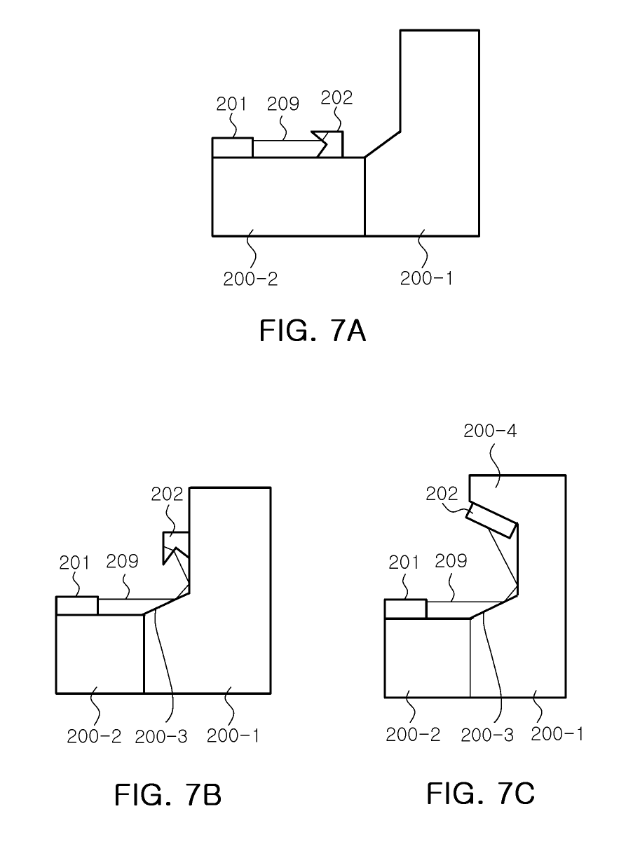

FIGS. 7A to 7C are views showing implementation examples of a platform according to an embodiment of the present invention.

First, with reference to FIG. 7A, the platform 200 includes a first platform 200-1 having the transmission line patterned thereon, and a second platform 200-2 having the transmission line patterned thereon and coupled to the first platform 200-1 at a right angle. Here, the transmission line of the first platform 200-1 and that of the second platform 200-2 are connected at an angle of 90°.

The reason for separately manufacturing the two respective platforms 200-1 and 200-2 with the transmission line 207 formed thereon, and then coupling them, is due to difficulty in directly forming the transmission line 207 on the platform 200 having a face at a right angle by 90°. However, if a technique of directly forming the transmission line on the platform 200 having a face at a right angle of 90° has been known, preferably, the platform 200 may be manufactured as a single platform.

The structure of the platform 200 may be variably changed within a range in which the transmission line 207 has a tilt angle as the right angle.

For example, as shown in FIG. 7B, besides the first platform 200-1 and the second platform 200-2, the platform 200 may further include a sloped face 200-3 formed at an inner corner area where the first platform 200-1 and the second platform 200-2 are in contact, and may allow the monitoring light receiving element 202 to be mounted on the first platform 200-1.

As shown in FIG. 7C, besides the first platform 200-1, the second platform 200-2, and the sloped face 200-3, the platform 200 may further include a protruded face 200-4 formed at an edge of the first platform 200-1 such that it faces the sloped face 200-3, and may allow the monitoring light receiving element 202 to be mounted on the protruded face 200-4.

Here, the sloped face 200-3 may be utilized as a reflector, and the monitoring light receiving element 202 may be mounted on the first platform 200-1, rather than on the second platform 200-2, and may perform a monitoring operation upon receiving light from the light source 201 made incident to the monitoring light receiving element 202 after being reflected by the sloped face 200-3.

Namely, the structure of the platform 200 may be modified as shown in FIGS. 7B and 7C and the monitoring light receiving element 202 may be mounted on the first platform 200-1. In such a case, the area of the second platform 200-2 is reduced to reduce the overall size of the light transmission apparatus 100 and improve cooling efficiency of the cooler 205.

In this manner, the utilization of the light transmission apparatus according an embodiment of the present invention can be enhanced by variably modifying the structure of the platform and variably changing the method of mounting the light source and the monitoring light receiving element.

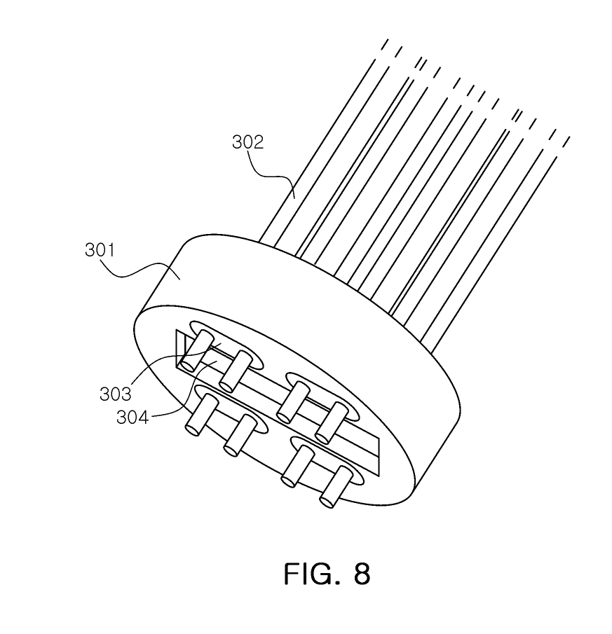

FIG. 8 is a view for explaining the structure the transistor outline (TO) stem package according to an embodiment of the present invention.

With reference to FIG. 8, the TO stem package 300 has a structure in which it allows the platform 200 to be mounted thereon and includes a lead pin 302 connected to the transmission line 207 through the bonding wire 400.

In detail, the TO stem package 300 may include a base 301 on which the platform 200 is mounted, a lead pin 302 connected to the transmission line 207 of the platform 200 through the bonding wire 400, and an insulator 303 formed in an area in which the base 301 and the lead pin 302 are in contact, insulating and impedance-matching the base 301 and the lead pin 302.

A cavity 304 is formed in a central area of the base 301, and the cooler 205 is mounted in the cavity 304, thus compensating for the height of the cooler 205 through the cavity 304.

Then, the distance between the base 301 and the platform 200 can be reduced to shorten the length of the wire bonding 400 connecting the lead pin 302 which penetrates the base 301 and the transmission line 207 of the platform 200 or shorten the lead pin 302 itself, thereby further improving the high frequency characteristics of the light transmission apparatus 100.

Also, the size of the light transmission apparatus 100 is reduced overall, increasing cooling efficiency of the cooler 205.

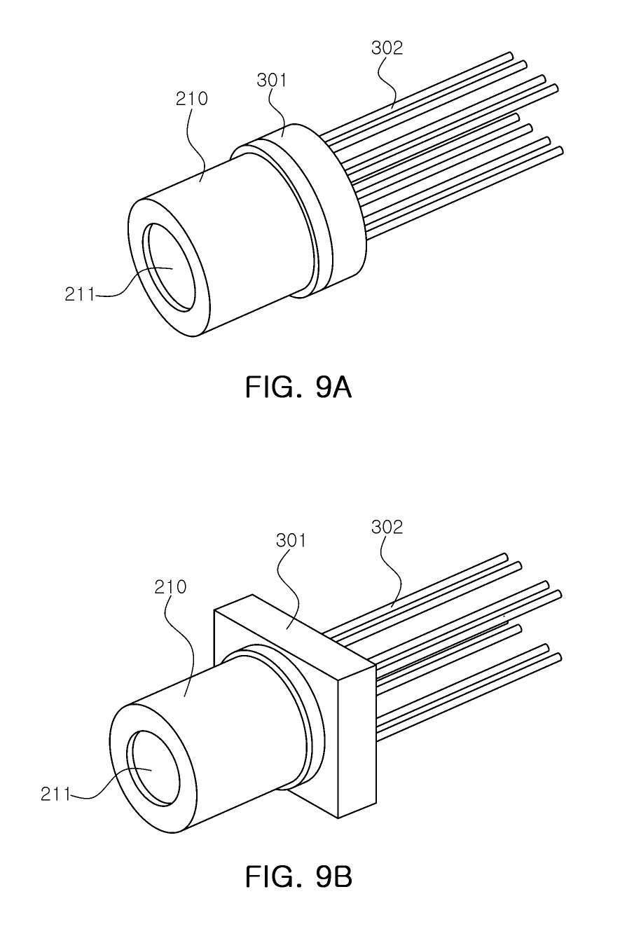

FIGS. 9A and 9B are views showing a configuration in which a cap is fastened to an optical transmission apparatus according to an embodiment of the present invention.

With reference to FIGS. 9A and 9B, the cap 210 mounted on the light transmission apparatus 100 is implemented to have a cylindrical shape covering the platform 200 and a central portion of an upper end face thereof is open.

As shown in FIGS. 9A and 9B, the base 301 of the TO stem package 300 may be formed to have a circular or a quadrangular shape. When the base 301 has a quadrangular shape, a contact area thereof with an external package can be increased, as compared with the base having a circular shape, so the base 301 can have high heat releasing efficiency.

In particular, when the base 301 is connected to a heat sink of an external package, even greater heat releasing efficiency can be obtained.

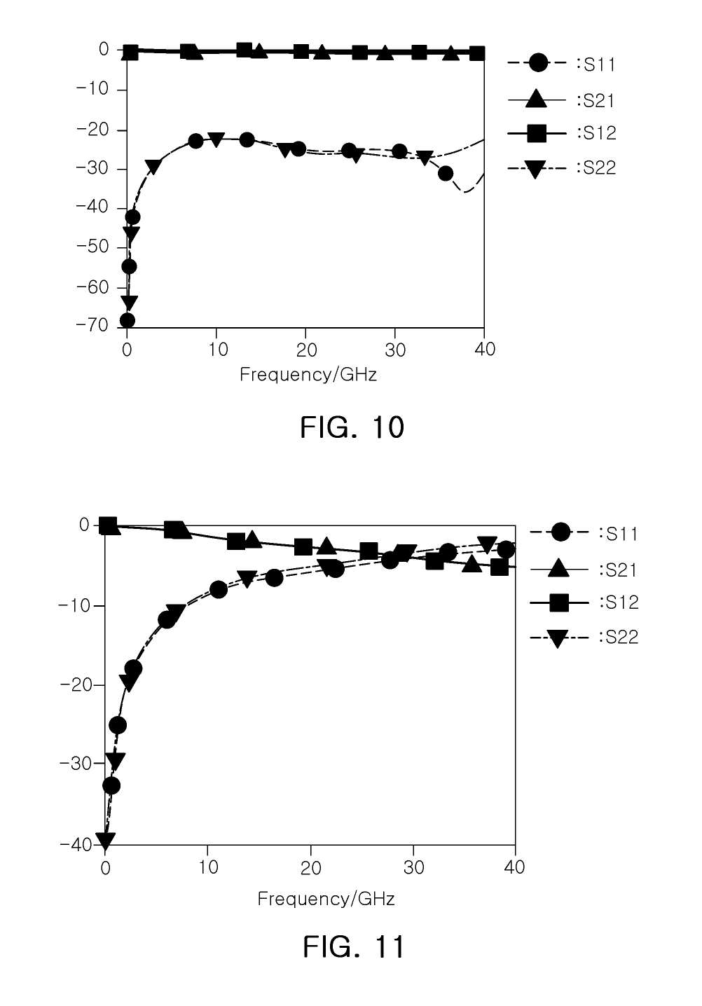

FIG. 10 is a graph of frequency characteristics of the transmission line of the platform itself according to an embodiment of the present invention. Here, the frequency characteristics refer to frequency characteristics of the transmission line of the platform when differential impedance is designed to be about 50 ohm in consideration of output impedance of the driving circuit of the light source.

With reference to FIG. 10, it is noted that, under the condition that the differential impedance is designed to be about 50 ohm in consideration of the output impedance of the driving circuit of the light source, the platform 200 has a 3 dB bandwidth of 40 GHz or greater and reflection loss characteristics of −20 dB or lower of 40 GHz or lower.

FIG. 11 is a graph of frequency transmission characteristics of the optical transmission apparatus after mounting the TO stem package on the platform according to an embodiment of the present invention, in which it is noted that the light transmission apparatus shows 3 dB bandwidth characteristics of about 20 GHz.

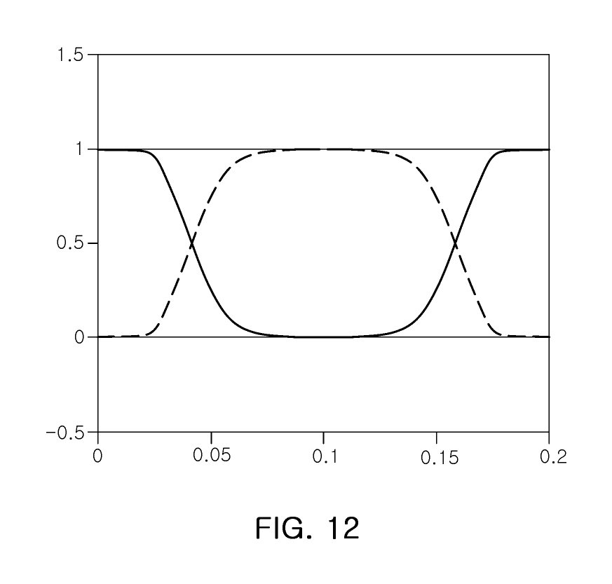

FIG. 12 is an eye diagram of output signals obtained when a signal having an optical transmission speed of 10 Gb/s is applied in a state in which the TO stem package is mounted on the platform according to an embodiment of the present invention. As shown in FIG. 12, it is noted that the light transmission apparatus according to an embodiment of the present invention has clean eye characteristics.

Finally, the light transmission apparatus according to an embodiment of the present invention may be fabricated by using a flexible printed circuit board (FPCB), instead of the lead pin, by cutting out the lead pin on the lower surface of the stem base.

As set forth above, according to embodiments of the invention, since the light transmission apparatus includes the cooler, temperature control characteristics can be provided thereby.

The light transmission apparatus according to an embodiment of the present invention proposes the platform having a transmission line patterned to have an angle of 90° and shortens the length of the bonding wire used to connect internal elements and the lead pin through the transmission line, thus improving the high frequency characteristics of a signal.

Also, in the case of bonding wires, the TO stem package is not required to be rotated, and the bonding wires can be easily bonded without using a lead pin having a special form for wire bonding.

Also, the cavity is additionally formed on the base of the TO stem package and the height of the cooler is compensated for through the cavity, thus further reducing the length of the bonding wire or the lead pin. Accordingly, the high frequency characteristics of a signal can be further improved.

Also, since the V-groove is formed in the platform and various elements such as a lens, an isolator, an isolator including a lens, and the like, can be mounted in a passive alignment manner by using the V-groove, an active alignment process such as laser welding, or the like, required for mounting an element can be omitted, and in particular, a degradation of optical coupling efficiency due to a post-weld shift in mounting a lens using laser welding can be solved.

Also, since the structure of the platform and the method for mounting the light source and the monitoring light receiving element are variably changed, the utilization of the optical transmission apparatus can be increased.

While the present invention has been shown and described in connection with the embodiments, it will be apparent to those skilled in the art that modifications and variations can be made without departing from the spirit and scope of the invention as defined by the appended claims.

What is claimed is:

1. An optical transmission apparatus including a cooler, the apparatus comprising:
a platform having a transmission line patterned to have an angle of 90°;
a light source mounted on the platform such that it is connected to the transmission line of the platform and generating light;
a cooler positioned under the platform and uniformly maintaining the temperature of the light source; and
a transistor outline (TO) stem package allowing the platform to be mounted thereon and having a lead pin connected to the transmission line of the platform through a bonding wire.

2. The apparatus of claim 1, wherein the platform comprises:
a first platform on which the transmission line is patterned; and
a second platform on which the transmission line is patterned, and coupled to the first platform at a right angle,
wherein the transmission line of the first platform and that of the second platform are connected at an angle of 90°.

3. The apparatus of claim 2, wherein the first platform and the second platform each have one face formed as a sloped face, the transmission line being patterned on an upper face and the sloped face of each of the first and the second platform, and the first and the second platform are bonded at a right angle using the sloped faces.

4. The apparatus of claim 3, wherein a solder is formed on the sloped faces of the first platform and the second platform, and the first platform and the second platform are bonded at a right angle through a flipchip bonding process.

5. The apparatus of claim 1, further comprising a monitoring light receiving element mounted on the platform and monitoring the light source.

6. The apparatus of claim 2, wherein the platform further comprises a sloped face formed at an inner corner area where the first and second platforms are in contact.

7. The apparatus of claim 6, further comprising:
a monitoring light receiving element mounted on the second platform or the first platform and monitoring the light source.

8. The apparatus of claim 6, wherein the platform further comprises a protruded face formed at the edge of the first platform such that it faces the sloped face.

9. The apparatus of claim 8, further comprising: a monitoring light receiving element mounted on the second platform or the protruded face of the first platform and monitoring the light source.

10. The apparatus of claim 1, wherein the platform further comprises a V-groove.

11. The apparatus of claim 10, further comprising: a lens, an isolator, or a lens including an isolator, mounted in the V-groove.

12. The apparatus of claim 1, wherein the TO stem package comprises:
a base allowing the platform to be mounted thereon;
a lead pin connected to the transmission line of the platform through a bonding wire; and
an insulator formed in an area in which the base and the lead pin are in contact.

13. The apparatus of claim 1, wherein the TO stem package further comprises a cavity formed in the base.

14. The apparatus of claim 13, wherein the cooler is mounted in the cavity.

15. The apparatus of claim 12, wherein the base has a circular or quadrangular shape.

16. The apparatus of claim 1, further comprising:
a thin film resistor formed on the transmission line or a chip resistor bonded to the transmission line.

17. The apparatus of claim 1, further comprising:
a thermistor mounted on the platform and connected to the transmission line.
